(19) United States
(12) Patent Application Publication
(10) Pub. No.: US 2010/0101393 A1
(43) Pub. Date: Apr. 29, 2010

(54) SAFETY STRUCTURE FOR SAW MACHINE

(75) Inventors: Jung-Huo CHEN, Taichung (TW); Pei-Ju Tsai, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/603,622

(22) Filed: Oct. 22, 2009

(30) Foreign Application Priority Data
Oct. 27, 2008 (TW) 097141176

(51) Int. Cl. B27G 19/02

(52) U.S. Cl. 83/478

(57) ABSTRACT

A safety structure for use in a saw machine includes two side guard plates arranged at left and right sides relative to a saw blade and having the rear sides thereof pivotally connected together. A guide unit has a connection plate connected between the front sides of the side guard plates in such a manner that one end of the connection plate is movable relative to the associated side guard plate so that when the safety structure is tilted with the saw blade for a slanting cut, the two side guard plates are pivoted in opposite directions. The guide unit prohibits the front ends of the side guard plates from being forced outwardly away from each other or squeezed inwardly toward each other, assuring a high level of operation safety.

### FIELD OF THE INVENTION

The present invention relates to a table saw and more particularly, to a safety structure for a saw machine.

### BACKGROUND

A typical saw machine includes a worktable and a saw blade (for example, a circular saw blade). During typical operation, the workpiece is pushed toward the saw blade and is cut into two pieces by the saw blade. To enhance operation safety, U.S. publication no. 2005/0235793 discloses a safety device for a saw machine provided to prohibit the projection of cut chips and dust toward the user. However, this design cannot completely eliminate injuries caused by accidental touching of the saw blade.

To avoid injuries caused by accidental touching of the saw blade, U.S. publication no 2007/0186739 discloses another design of a safety device for a saw machine. According to this design, the safety device includes two guard plates arranged at two sides relative to the saw blade, assuring operation safety. Similar designs are seen in U.S. publication nos. 2007/0186741 and 2007/0000366. When operating a saw machine to cut a workpiece, the workpiece may be cut vertically or obliquely. When performing a slanting or oblique cut, the safety device must be tilted with the saw blade. When tilting the safety device with the saw blade to the left side, the left guard plate will be in contact with the worktable and the right guard plate will be suspended above the worktable. If there is a large gap between the worktable and the right guard plate, the user may touch the saw blade accidentally, thus causing an injury.

Referring to FIGS. 1 and 2, U.S. publication nos. 2008/0022826 and 2008/0022827 show the use of a safety device for a saw machine. According to this design, the safety device 1 includes a top guard plate 11 having a substantially V-shaped cross section, two side guard plates 12, sliding slots 13 respectively formed in the rear sides of the side guard plates 12, and guide rods 14 respectively fixedly provided at the rear side of the top guard plate 11 and respectively coupled to the sliding slots 13. By means of coupling between the sliding slots 13 and the guide rods 14, the side guard plates 12 are movable relative to each other when performing a slanting cut, thereby avoiding the aforesaid problem. However, because the guide rods 14 are provided at the rear side of the top guard plate 11, the front sides of the side guard plates 12 tend to be forced apart or squeezed toward each other, increasing the difficulty of cutting operation and resulting in squeezing damage to the workpiece.

As stated above, a regular saw machine safety device 1 has guard plates 11 and 12 arranged at the top side and the two opposite lateral sides relative to the saw blade to avoid workpiece rebound and injuries caused by accidental touching of the saw blade. To achieve sufficient protection during a slanting cut, the side guard plates 12 must be movable relative to each other. However, the aforesaid prior art designs suffer from the above-mentioned drawbacks. Accordingly, there is a need for a safety device for use in a saw machine, which eliminates the drawbacks of the aforesaid prior art designs.

### SUMMARY

The present disclosure has been accomplished under the circumstances in view. Thus, the present disclosure provides a safety device for a saw machine, which assures a high level of safety during the operation of the saw machine.

To achieve this and other objects, a safety structure for a saw machine includes two side guard plates and a guide unit. The two side guard plates are arranged at left and right sides relative to the saw blade of the saw machine. The side guard plates have the respective rear sides thereof pivotally connected together. The guide unit is mounted at the front sides of the side guard plates for guiding the side guard plates to a tilt position for slanting or oblique cuts. The guide unit includes a connection plate. The connection plate has two opposite ends respectively connected to the front sides of the side guard plates. At least one of the two opposite ends is a movable end that is movable relative to the associated side guard plate.

By means of the arrangement of the guide unit at the front side, the safety structure prohibits the front ends of the side guard plates from being forced outwardly away from each other or squeezed inwardly toward each other, thereby avoiding squeezing damage to the workpiece and increasing the level of safety.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is an exploded view of a safety device for a saw machine according to the prior art.

FIG. 2 is an elevational view showing a tilted status of the prior art safety device on the saw machine.

FIG. 3 is a perspective assembly view of a safety structure for a saw machine according to a first embodiment of the present disclosure.

FIG. 4 is a sectional view taken along line IV˜IV of FIG. 3.

FIG. 5 is a view similar to FIG. 4, showing the safety structure in a tilted position.

FIG. 6 is a schematic sectional view of a safety structure for a saw machine in accordance with a second embodiment of the present disclosure.

FIG. 7 is a view similar to FIG. 6, showing the safety structure in a tilted position.

FIG. 8 is a schematic sectional view of a safety structure for a saw machine in accordance with a third embodiment of the present disclosure.

FIG. 9 is a view similar to FIG. 8, showing the safety structure in a tilted position.

FIG. 10 is schematic sectional view of a safety structure for saw machine in accordance with a fourth embodiment of the present invention.

FIG. 11 is similar to FIG. 10, showing the safety structure tilted.

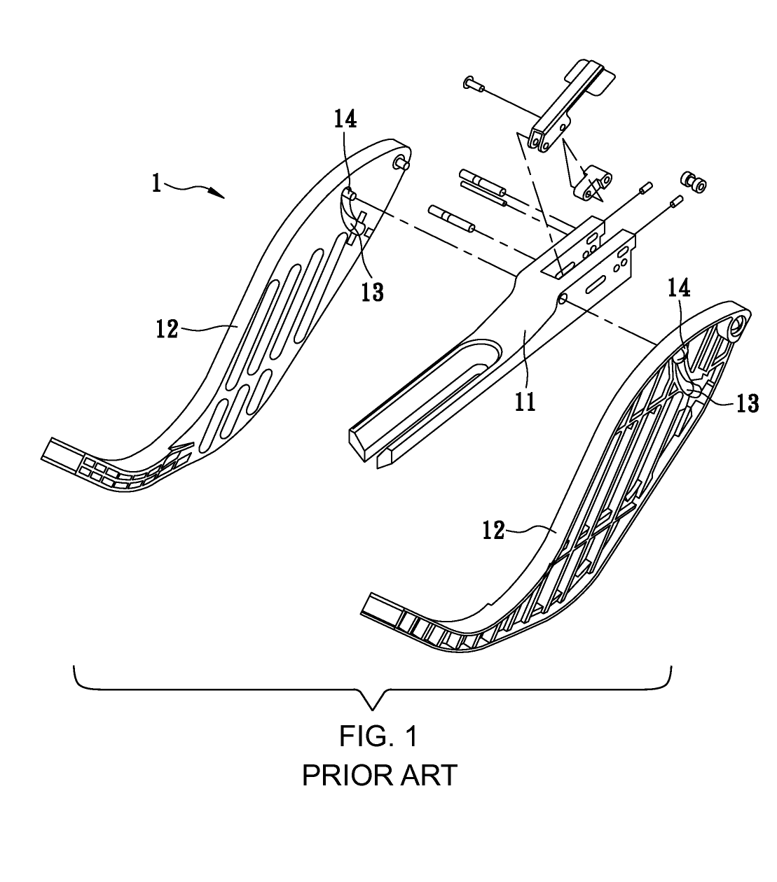

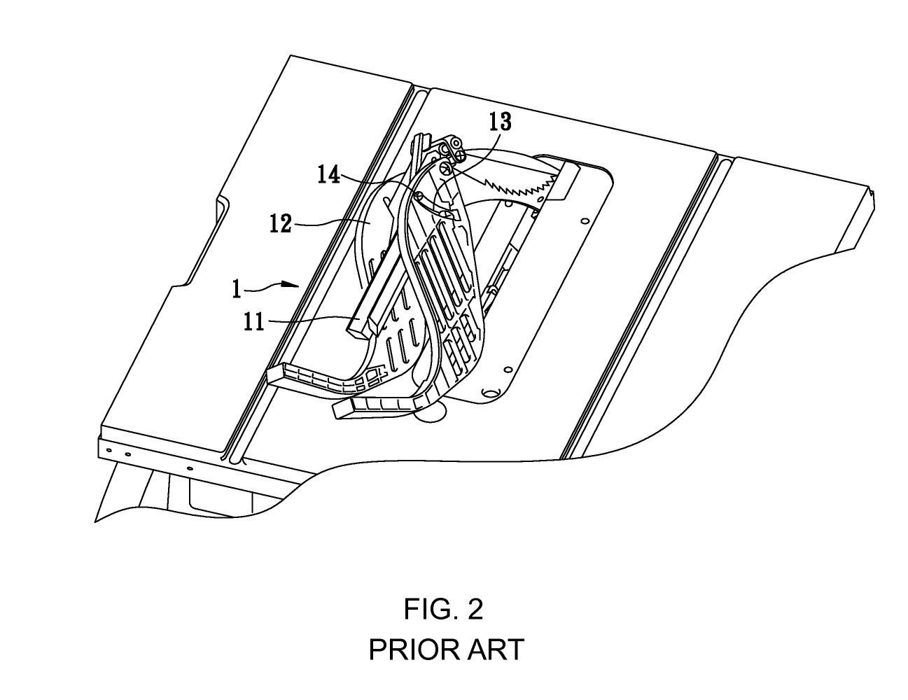

### DETAILED DESCRIPTION

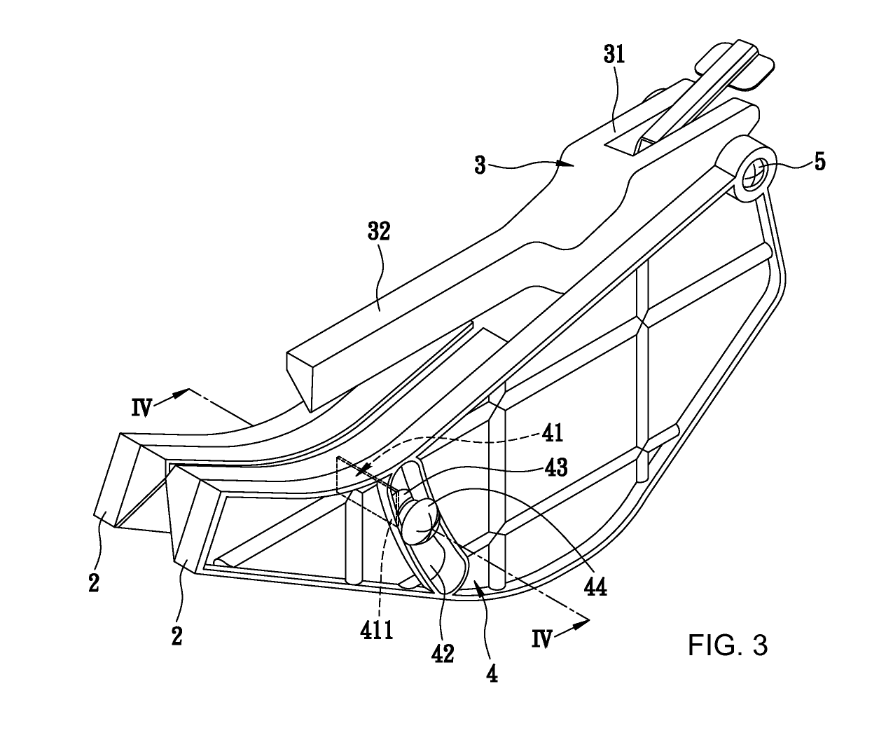

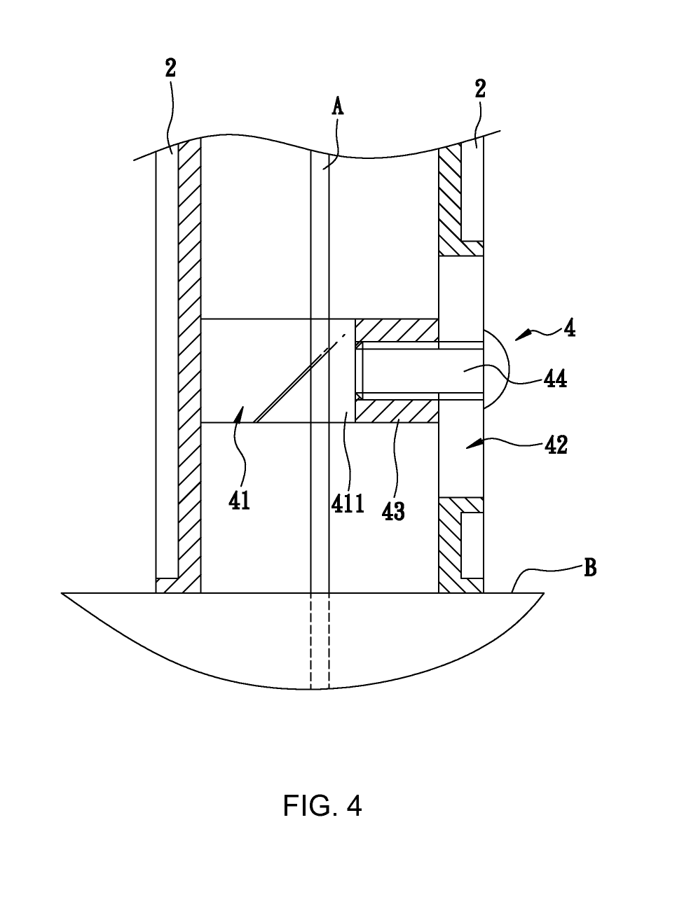

Referring to FIGS. 3 and 4, a safety structure for a saw machine in accordance with a first embodiment of the present disclosure is shown having two side guard plates 2, a top guard plate 3, and a guide unit 4.

The side guard plates 2 are respectively arranged at left and right sides relative to a saw blade A. The side guard plates 2 and the top guard plate 3 have the respective rear sides thereof pivotally connected together with a pivot bolt 5 so that the side guard plates 2 can be rotated about the pivot bolt 5 with respect to the top guard plate 3.

The top guard plate 3 is positioned between the side guard plates 2 above the saw blade A. The pivot bolt 5 is inserted through the rear side of the top guard plate 3. The top guard plate 3 has a rear connection portion 31 pivotally coupled to the pivot bolt 5, and an elongated front guard portion 32 forwardly extended from the rear connection portion 31. The elongated front guard portion 32 is disposed relatively closer to one side guard plate 2 and is suspended at one lateral side thereof relative to the saw blade A.

It is to be understood that the safety structure in accordance with the first embodiment of the present disclosure is adapted for use in a left-tilt miter saw so that the elongated front guard portion 32 is disposed relatively closer to the left side guard plate 2. Under normal working conditions, the left half design of the elongated front guard portion 32 imparts a wide field of view for enabling the user to better observe the cutting operation. During a slanting cut, the safety structure effectively prevents rebound of the workpiece while still imparting a wide field of view to let the user better observe the cutting operation.

The guide unit 4 is disposed near the front side of the side guard plates 2 for guiding the safety structure to a tilt status during a slanting cut. The guide unit 4 includes a connection plate 41 connected between the front sides of the side guard plates 2. The connection plate 41 is made of a transparent material, having at least one movable end 411 that is movable relative to one side guard plate 2 during a slanting cut.

According to this first embodiment, the guide unit 4 further includes a sliding slot 42 formed in one side guard plate 2, a screw nut 43 fixedly provided at the movable end 411 of the connection plate 41, and a guide screw bolt 44 inserted through the sliding slot 42 and threaded into the screw nut 43 to guide the movement of the movable end 411 along the sliding slot 42. The head of the guide screw bolt 44 has a diameter greater than the width of the sliding slot 42 so that the guide screw bolt 44 will not fall out of the sliding slot 42 while being moved along the sliding slot 42.

Because the guide unit 4 is provided at the front side of the side guide plates 2, it prohibits the front ends of the side guard plates 2 from being forced outwardly away from each other or squeezed inwardly toward each other, thus increasing the level of safety. According to this first embodiment, one sliding slot 42, one screw nut 43 and one guide screw bolt 44 are sufficient to provide the desired level of safety and observability of the cutting operation.

Further, the sliding slot 42 according to this first embodiment is formed in the right side guard plate 2, and the connection plate 41 is formed integral with the left side guard plate 2. Further, the connection plate 41 is made of a transparent material in a flat shape, thereby minimizing visual interference.

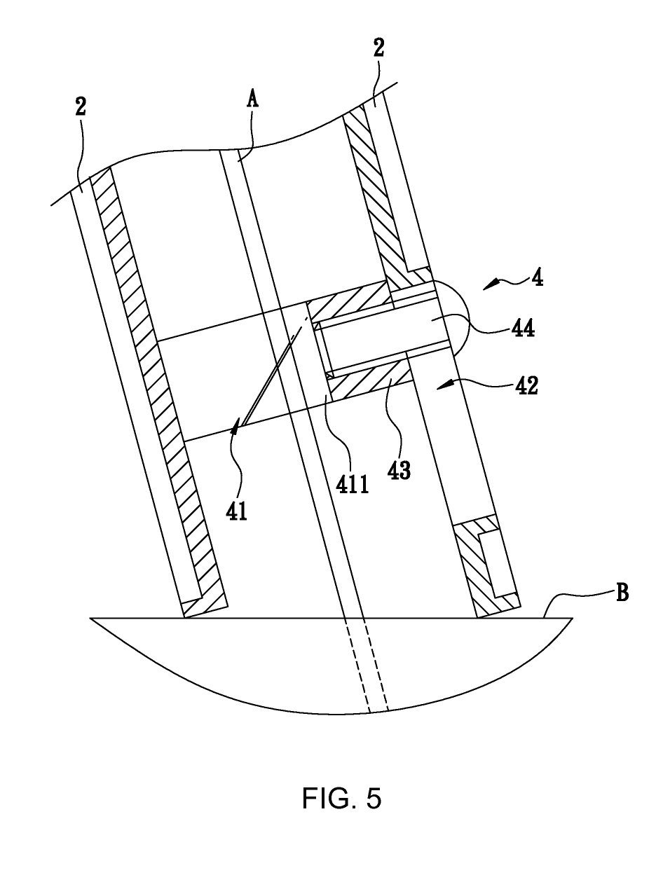

Referring to FIGS. 3 and 5, when the saw machine is set for a slanting cut, for example, left slant, the side guard plates 2 are tilted leftwards. When the safety structure is tilted leftwards, the left side guard plate 2 is in contact with the worktable B and is pivoted about the pivot bolt 5 toward the top side, and at the same time, the right side guard plate 2 is rotated about the pivot bolt 5 toward the bottom to offset the gap between the left side guard plate 2 and the worktable B. Further, when the right side guard plate 2 is rotated downwards and into contact with the worktable B, the guide screw bolt 44 is moved upwards along the sliding slot 42 to let the two side guard plates 2 be pivoted in opposite directions in order to avoid an increase of the gap between the side guard plates 2 and the worktable B and to prevent the user from accidental contact with the saw blade A.

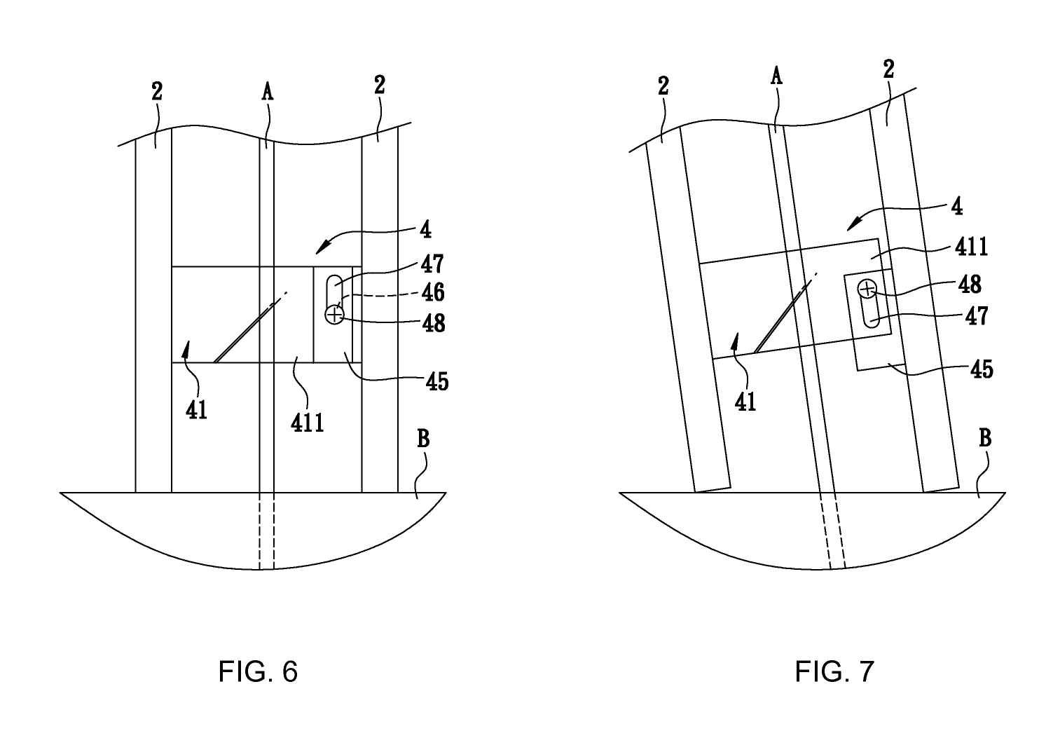

FIGS. 6 and 7 show a safety structure for a saw machine in accordance with a second embodiment of the present disclosure. This second embodiment is substantially similar to the aforesaid first embodiment with the exception that the guide unit 4 according to this second embodiment further includes a lug 45 fixedly provided at the right side guard plate 2 adjacent to the movable end 411 of the connection plate 41, a screw hole 46 formed in one of the lug 45 and the movable end 411, an opening 47 formed in the other of the lug 45 and the movable end 411, and a movable screw bolt 48 inserted through the opening 47 and threaded into the screw hole 46. The movable screw bolt 48 is movable along the opening 47.

According to this second embodiment, the screw hole 46 is formed in the movable end 411 of the connection plate 41, and the opening 47 is formed in the lug 45. By means of the space provided by the opening 47, the movable screw bolt 48 can be moved in the opening 47 when the safety structure is tilted during a slanting cut to have the two side guard plates 2 be pivoted in opposite directions.

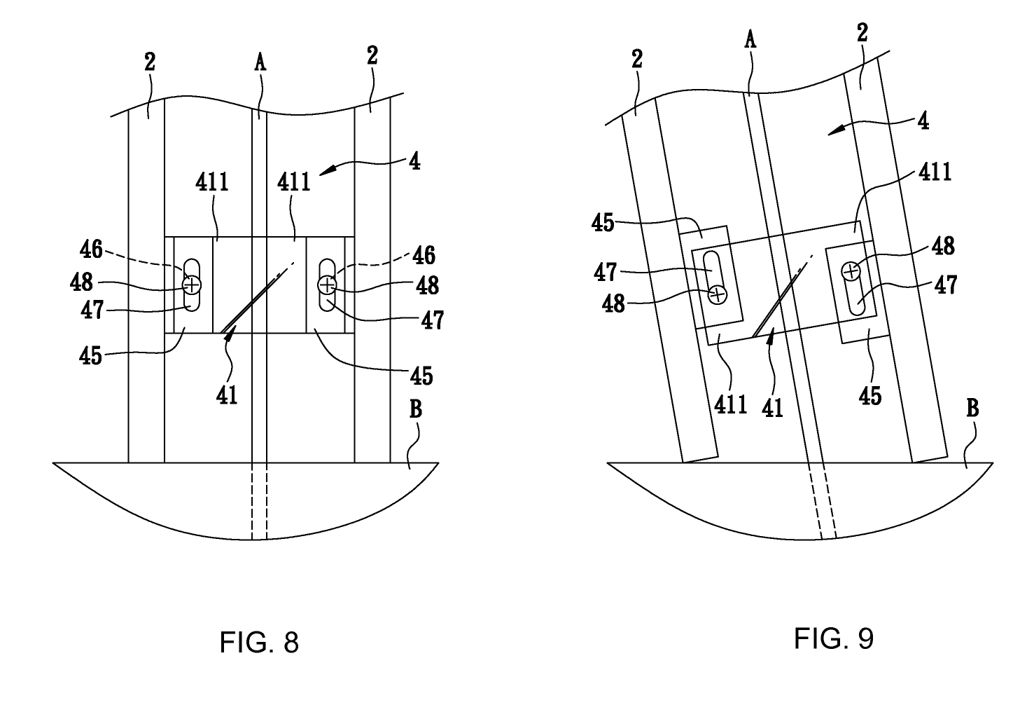

FIGS. 8 and 9 show a safety structure for a saw machine in accordance with a third embodiment of the present disclosure. This third embodiment is substantially similar to the aforesaid second embodiment with the exception that the connection plate 41 has two opposite movable ends 411 respectively movably coupled to the two side guard plates 2 in the same manner as the connection between the movable end 411 and the associated side guard plate 2 in the aforesaid second embodiment, i.e., the number of the lug 45, screw hole 46, opening 47, and movable screw bolt 48 is doubled.

Because the connection plate 41 has two opposite movable ends 411, the openings 47 according to this third embodiment can be made relatively shorter than the aforesaid second embodiment, while still achieving the same effects as the aforesaid second embodiment.

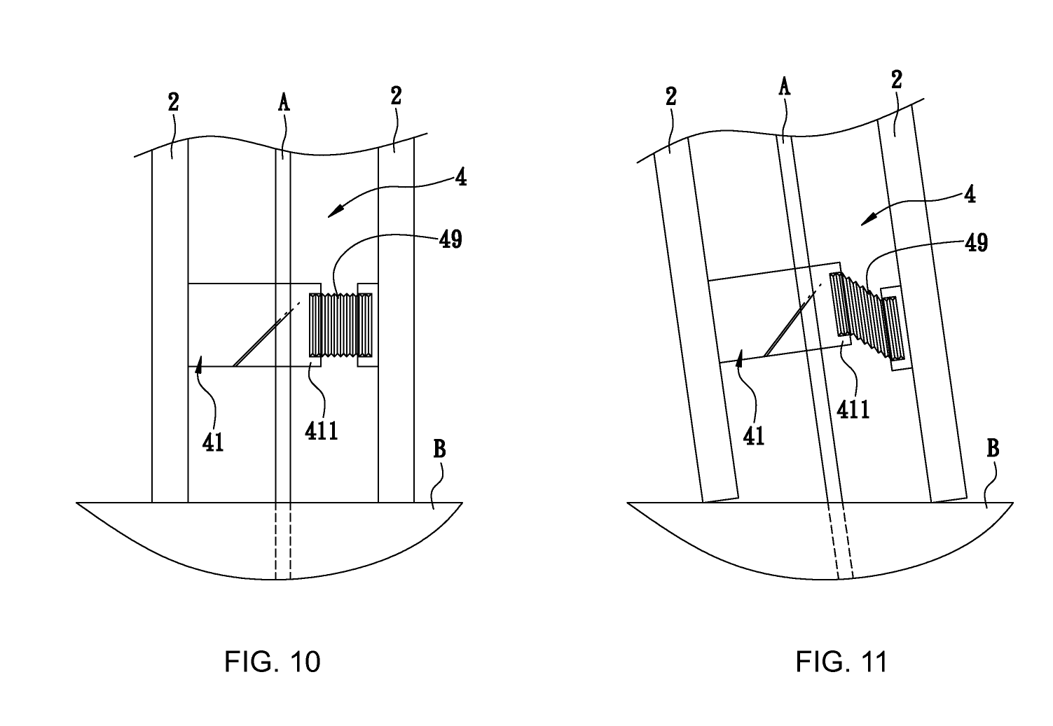

FIGS. 10 and 11 show a safety structure for saw machine in accordance with a fourth embodiment of the present disclosure. This fourth embodiment is substantially similar to the aforesaid first embodiment with the exception that the guide unit 4 according to this fourth embodiment further includes a flexible member 49 connected between one side guard plate 2 and the movable end 411 of the connection plate 41.

According to this fourth embodiment, the flexible member 49 is a bellows tube. When the safety structure is titled for a slanting cut, the safety structure utilizes the spring power of the flexible member 49 to offset the gap required during the opposed movement between the two side guard plates, thereby minimizing the gap between the side guard plates 2 and the workpiece B and assuring a high level of safety.

In conclusion, the arrangement of the guide unit 4 at the front sides of the side guard plates 2 enables the safety structure to provide protection during a slant cut and to prohibit the front sides of the side guard plates 2 from being forced outwardly away from each other or squeezed inwardly toward each other.

Further, the arrangement of the elongated front guard portion 32 of the top guard plate 3 at the left side relative to the saw blade A and the transparent design of the connection plate 41 increase visual clarity during operation of the saw machine, thereby assuring a high level of safety.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A safety structure for use in a saw machine, comprising:
two side guard plates arranged at left and right sides relative to a saw blade, said side guard plates each having a front side and a rear side opposite to said front side, and being pivotally connected together at the rear sides thereof; and
a guide unit mounted at said front sides of said side guard plates for guiding said side guard plates to a tilt position, said guide unit including a connection plate having two opposite ends respectively connected to said front sides of said side guard plates, at least one of said two opposite ends being movable relative to the associated side guard plate.

2. The safety structure as claimed in claim 1, wherein said guide unit further comprises a sliding slot formed in one of said side guard plates, a screw nut fixedly located on the movable end of said connection plate, and a guide screw bolt inserted through said sliding slot and threaded into said screw nut to guide movement of said movable end of said connection plate along said sliding slot.

3. The safety structure as claimed in claim 2, wherein said guide screw bolt has a head that is relatively larger than the width of said sliding slot.

4. The safety structure as claimed in claim 1, wherein said connection plate is transparent.

5. The safety structure as claimed in claim 1, wherein said guide unit further comprises a lug fixedly located on one of said side guard plates adjacent to said movable end of said connection plate, a screw hole located on one of said lug and said movable end of said connection plate, an opening formed in the other of said lug and said movable end of said connection plate, and a movable screw bolt inserted through said opening and threaded into said screw hole and movable along said opening.

6. The safety structure as claimed in claim 1, wherein said two opposite ends of said connection plate are respectively movable ends relative to said side guard plates; said guide unit further comprises two lugs respectively fixedly located on said side guard plates adjacent to the two movable ends of said connection plate, screw holes respectively formed in each one of said lugs and the movable ends, openings respectively formed in the other of said lugs and the movable ends, and movable screw bolts respectively inserted through said openings and threaded into said screw holes and respectively movable along said openings.

7. The safety structure as claimed in claim 1, wherein said guide unit further comprises a flexible member connected between the movable end of said connection member and one of said side guard plates.

8. The safety structure as claimed in claim 7, wherein said flexible member is a bellows tube.

9. The safety structure as claimed in claim 1, further comprising a top guard plate connected between said rear sides of said side guard plates above said saw blade, said top guard plate having a rear connection portion connected between said rear sides of said side guard plates and a front guard portion forwardly extended from said rear connection portion and suspended at one lateral side relative to said saw blade adjacent to one of said side guard plates.

10. The safety structure as claimed in claim 9, wherein said rear sides of said side guard plates are pivotally connected to said rear connection portion of said top guard plate.
